(19) United States
(12) Patent Application Publication
(10) Pub. No.: US 2013/0030683 A1
(43) Pub. Date: Jan. 31, 2013

(54) Method For Accurately Timing Stations On A Public Transportation Route

(71) Applicants: Tomer Y. Morad, Tel Aviv (IL); Shahar Daniel, Kiryat Ono (IL); Guy Cohen, Ramat Gan (IL)

(72) Inventors: Tomer Y. Morad, Tel Aviv (IL); Shahar Daniel, Kiryat Ono (IL); Guy Cohen, Ramat Gan (IL)

(21) Appl. No.: 13/640,487

(22) PCT Filed: Apr. 27, 2010
(86) PCT No.: PCT/IL11/00332

§ 371 Date: Oct. 11, 2012

(30) Foreign Application Priority Data
Apr. 27, 2010 (IL) 205371

(51) Int. Cl. G08G 1/123

(52) U.S. Cl. 701/300

(57) ABSTRACT

The present invention relates to a method for timing the arrival of a public transportation vehicle to a station on a route comprising the steps of: (a) receiving at least one said route for said public transportation vehicle; (b) receiving the location of at least one said station on said route; (c) receiving at least one GPS reading, indicative of the location of said public transportation vehicle; (d) calculating the location of said public transportation vehicle in relations to said route; (e) calculating the distance of the route between said location of said public transportation vehicle to said station; and (f) calculating the time required for said public transportation vehicle to travel to said station based on at least said distance to said station.

### FIELD OF THE INVENTION

The present invention relates to the field of public transportation. More particularly, the invention relates to a method for timing stations on a public transportation route using GPS readings.

### BACKGROUND OF THE INVENTION

Today, some of the public transportation vehicles offer their passengers information display systems. These systems typically display general information, such as weather forecasts and news, and location related information, such as a map of the surroundings and location related commercial information. Some of these public transportation systems also announce the time of arrival of the stations ahead.

One of the known systems for automatically locating and announcing stations includes a database with the stations coordinates and a GPS receiver, which provides periodic latitude and longitude coordinate readings. The automated announcing system, which is coupled to the GPS receiver, can track the traveling coordinates periodically during traveling en route. The tracked coordinates are compared to the predetermined list of coordinates of the stations, and when the vehicle is in proximity to a station, the information related to that station is announced, such as described in U.S. Pat. No. 5,808,565. Nevertheless, the described system is inaccurate and error prone.

### SUMMARY OF THE INVENTION

It is an object of the present invention to provide a method for measuring the distance to a station on a public transportation route.

It is another object of the present invention to provide a method for timing the arrival of a public transportation vehicle to its designated stations, automatically and accurately.

It is still another object of the present invention to provide a method for automatically determining a detour from a public transportation route.

It is still another object of the present invention to provide a method for compensating for the inertial drift of a GPS receiver.

Other objects and advantages of the invention will become apparent as the description proceeds.

The present invention relates to a method for timing the arrival of a public transportation vehicle to a station on a route comprising the steps of: (a) receiving at least one said route for said public transportation vehicle; (b) receiving the location of at least one said station on said route; (c) receiving at least one GPS reading, indicative of the location of said public transportation vehicle; (d) calculating the location of said public transportation vehicle in relations to said route; (e) calculating the distance of the route between said location of said public transportation vehicle to said station; and (f) calculating the time required for said public transportation vehicle to travel to said station based on at least said distance to said station.

Preferably, the GPS readings are used for calculating the direction of the vehicle.

Preferably, the GPS readings are used for calculating the velocity of the vehicle.

In one embodiment, the GPS readings are processed using information from the speedometer or the odometer of the vehicle to determine the location of the vehicle.

Preferably, the GPS readings are also used to ascertain that the vehicle is traveling en route.

Preferably, the calculating of the location of said public transportation vehicle in relations to said route comprises the steps of: (a) determining the direction of the vehicle using the GPS readings; (b) identifying the first route edge; (c) calculating the distance from the current location of said vehicle to said identified route edge; (d) searching the routes database for other route edges following said identified edge in said route whose direction is within the preset tolerance angle from said vehicle direction; (e) finding the edge with the minimum distance from current location among said found route edges; and (f) determining that the location of the vehicle in relation to said route is the location on the said edge whose distance to said vehicle is minimal.

In one embodiment, the found route edge with the minimum distance to the vehicle location is used as the first route edge.

In one embodiment, it is determined that the vehicle has strayed from the route if no route edges are found whose direction is within the preset tolerance angle of the direction of the vehicle.

In one embodiment, it is determined that the vehicle has strayed from the route if no edges are found whose distance from the current location of said vehicle is within the preset distance tolerance.

Preferably, the found time for the public transportation vehicle to travel to the station is used for announcing the arrival to the station.

In one embodiment, it is determined that the vehicle is traveling en route if an edge is found whose direction is within the preset angle tolerance of the direction of the vehicle, and its distance from the current vehicle location is within the preset distance tolerance.

### BRIEF DESCRIPTION OF THE DRAWINGS

In the drawings:

FIG. 1 is a block diagram of the system for accurately timing a station on a public transportation route according to an embodiment of the invention.

FIG. 2 is a flow chart of the method for accurately timing a station on a public transportation route according to an embodiment of the invention.

FIG. 3 is a schematic top view diagram depicting a road lane for describing the use of a system for accurately timing the stations, according to an embodiment of the invention.

FIG. 4 is a schematic top view diagram depicting another road lane for describing the use of a system for accurately timing the stations, according to an embodiment of the invention.

### DETAILED DESCRIPTION OF PREFERRED EMBODIMENTS

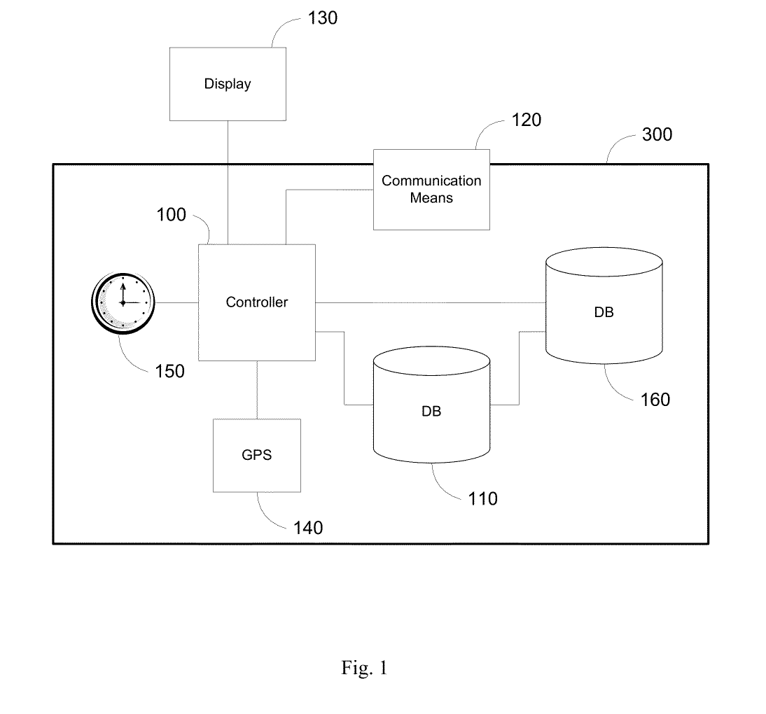

FIG. 1 is a block diagram of the system for accurately timing a station on a public transportation route according to an embodiment of the invention. By the phrase ‘accurately timing a station’ it is meant to include time measurement, which is typically more accurate than the time measurement of the prior art stated above, for predicting the arrival of the public transportation vehicle at the station. In this embodiment, the system 300 is preferably located on a traveling vehicle, which may be a bus, car, ship, boat, plane or any other public transportation vehicle. The system 300 has a controller 100, such as a processor, microprocessor, or any other kind of control-unit for controlling the system 300. The system also comprises a GPS receiver 140 for providing the coordinates of the approximated location and two databases (DB) 110 and 160, where the two DB 110 and 160 may be stored in the same repository, or any other constellation thereof. The DB 110 is used for storing the route(s) of the public transportation vehicle and the DB 160 is used for storing the coordinates of the stations. One of the tasks of the controller 100 is to accurately calculate the distance from the present location of the vehicle, as determined by the GPS readings received from GPS receiver 140, to the following station(s) en route. The calculation is based on measuring the distance of the route from the present location to the following station(s). Thus the controller 100 can display to the passengers the distance, i.e. the length of the route, to the next station. Furthermore, by periodically calculating the distance to the next station, the controller 100 can approximate the time remaining to arrive at the next station. The system may have a display 130 for displaying information, and communication means 120 for communicating information. The system may also have a clock 150 for timing purposes.

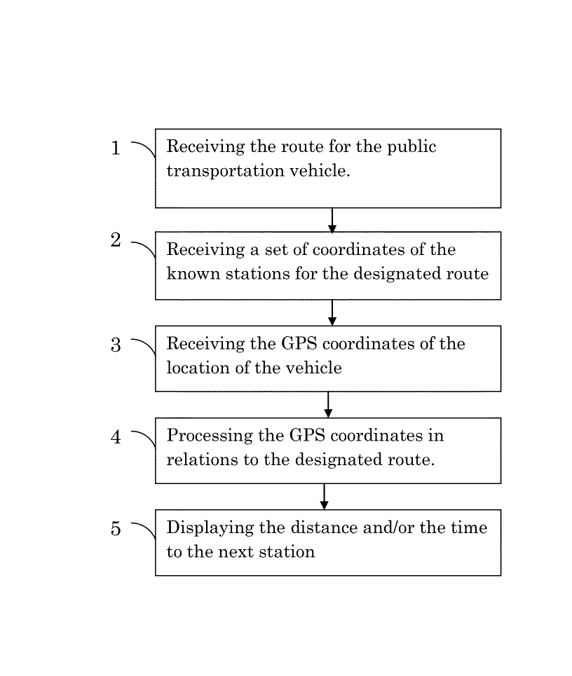

FIG. 2 is a flow chart of the method for accurately timing a station on a public transportation route according to an embodiment of the invention. In this embodiment the described vehicle is a public transportation vehicle which is expected to travel on a known route and stop at known stations. In step 1, the system 300, as described in relations to FIG. 1, receives the route for the public transportation vehicle. The received route is actually an electronic formation of the physical route and it may belong to any route formation technique or method such as the Directed Acyclic Graph (DAG) method, where each vertex represents a geographic location and each edge represents a linear geographic line between two locations. The first and last vertices in the route have only one edge, and all other vertices have exactly two edges. There are many methods for finding, forming, presenting and storing the route electronically; such methods may be found in U.S. Pat. No. 6,366,851. There is no need to store a map of the whole city or area, only the required information concerning the route. In one of the embodiments the received route includes alternating routes for the public transportation vehicle. In step 2, the system 300 receives the coordinates of the stations for the designated route. The stations are received in relations to the route received in step 1, where each station may be linked to a specific location on the route. For example, if a route includes traveling on a street back and forth, each of the stations on that street is linked, either with the route of traveling back or the route of traveling forth. The data received in steps 1 and 2 may be received in parallel, one after another, before the vehicle has begun its traveling, or after the beginning of traveling, or in any other way as long as the data concerning the route and the location of the stations is received by the system 300. The data may be received in any known way of communicating data, wired or wireless, such as by cellular networking, Blue-Tooth, direct uploading from a repository, etc. In step 3 the system receives the GPS coordinates of the traveling vehicle from the GPS receiver 140. The received GPS readings may have a drift, as known in the art; therefore, the received GPS coordinates may not be accurate. In step 4 the GPS coordinates received from GPS receiver 140 are processed in relations to the received route in the DB 110. Each location derived from the GPS receiver 140 may be used for calculating the distance to the following station based on the distances of the route. In one embodiment, the GPS readings are assessed for finding the location and the direction of the vehicle. In an embodiment the GPS readings are also used for finding the velocity of the vehicle. In one embodiment the GPS readings are processed using information from the speedometer of the vehicle, the odometer, or any other known method to determine the location of the vehicle. The GPS coordinates may also be assessed in order to ascertain that the vehicle is traveling en route. Since the GPS coordinates may have a drift, as known in the art, a slight drift from the coordinates of the route is tolerable, and the system calculates the nearest location on the route and uses it as the coordinate of the vehicle. Calculation of the drift is described in the following paragraph. Nevertheless, if the received GPS coordinates imply that the vehicle is traveling on a different route than the one stored in the DB, then the controller 100 may decide that the vehicle has left the preset designated route and taken a different route. At this point if the controller 100 has arrived at such a decision, that the vehicle is traveling a different route than the stored route, the controller 100 may continue to supervise the incoming GPS readings for ascertaining when the vehicle returns to its designated stored route. During the detour from the designated route the system 300 may stop presenting information related to the route and may present general information. In one embodiment the controller 100 may also try to match the incoming GPS readings during a detour with alternative routes in the database 110 in order to estimate the traveling distance and time to the next station. During the traveling en route the system 300 may calculate the traveling distance to the next station using the received GPS readings and information from both DB 110 and 160 about the location of the next station and the information about the route leading to that station. Calculating the distance is more accurate than calculating the time to the next station as the time depends on a number of interchanging factors such as traffic jams and stop lights. Thus by calculating the distance to the next station it is possible to provide the distance information to the passenger which is more accurate than the time estimation to the next station. Furthermore, by calculating the distance to the next station, the system is capable of presenting to the passengers a more accurate estimation of time left to the next station, where the time estimate may be updated continuously based on the advances in displacement and time of the present traveling. For example if a traffic jam occurred at the beginning of the travel then there is a higher probability that more traffic jams are present and therefore the time estimate can be updated accordingly. In step 5 the information concerning the distance and/or the time to the next station may be displayed on display 130 to the passengers of the vehicle. Steps 3, 4 and 5 may be preformed periodically and continuously for updating and assessing the present location of the vehicle en route. By continuously it is meant to include any time propagation such as every second.

In one embodiment, finding whether the vehicle has strayed from its route is attained during the calculation of the distance of the vehicle from the route. The distance of the vehicle from the route is calculated by receiving the GPS reading of the vehicle periodically. The GPS reading is compared with a corresponding older GPS reading distanced approximately 10 m from the current GPS reading. The direction of the vehicle is then calculated using the current GPS reading and the older corresponding GPS reading. At this stage part of the passed route is processed for finding the closest last route edge traveled by the vehicle. If none is found the first edge of the route may be used. Then, the distance from the current location to the previously identified route edge is calculated. At this point the database of the route is searched for finding expected upcoming edges in the route whose direction is at most 45 degrees from the current vehicle direction. Then, the minimum distance from the current location to each of these edges is calculated. The edges whose calculated distance is outside of the tolerance range of 20 m are filtered. The remaining edge that is closest to the current location is chosen. If an edge is not found then the system deduces that the vehicle has strayed form the designated route. If an edge is found then the distance from the route is the distance from the chosen edge. The chosen edge is also marked as the last route edge traveled by the vehicle. After the system deduced that the vehicle has strayed form the designated route it may continue receiving the GPS readings of the current location of the vehicle. The system may continue the calculations as described above. When a minimum distance from the current location to any of the edges is under the tolerance range of 20 m, for instance, the system can conclude that the vehicle has reentered the route.

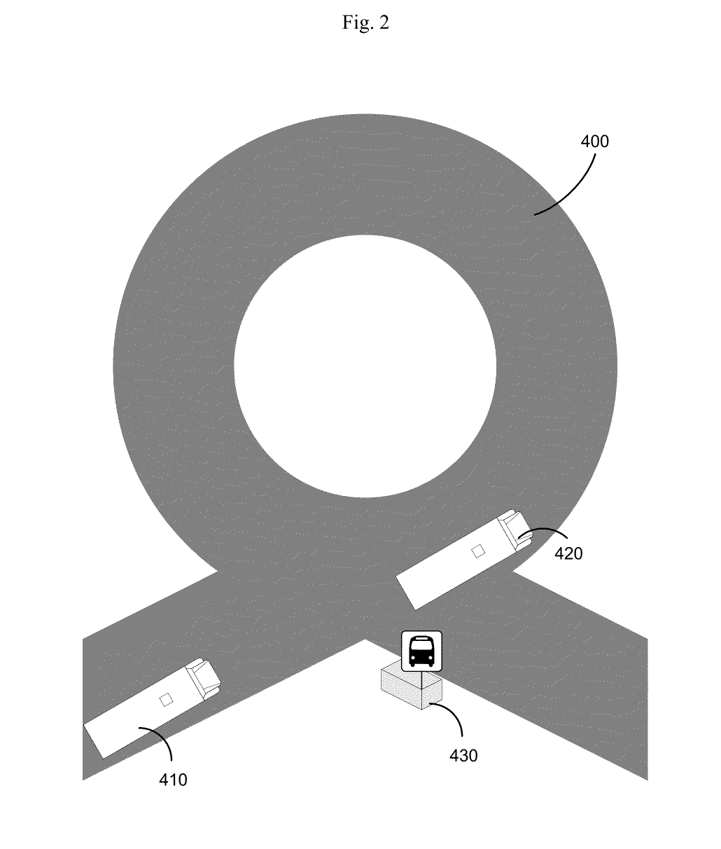

FIG. 3 is a schematic top view diagram depicting a road lane for describing the use of a system for accurately timing the stations, according to an embodiment of the invention. In this embodiment both buses 410 and 420 are traveling in the same lane, following the same public transportation route, and are designated to stop at the bus station 430. As depicted, the buses following the public transportation route are required to turn around in a traffic circle 400 before stopping at bus station 430. Although, technically, bus 410 is only a short distance from the bus station 430, the system 300, as described in relations to FIG. 1, does not calculate the aerial distance to the bus station 430, on the contrary, the system 300 calculates the distance to the bus station 430 based on the distance of the route which takes into consideration the perimeter of the traffic circle 400. Thus the system 300 is able to calculate the travelling distance to the bus station 430 more accurately. Furthermore, by calculating the travelling distance to the bus station 430 more accurately, the system 300 is also capable of predicting the arrival time at bus station 430 more accurately.

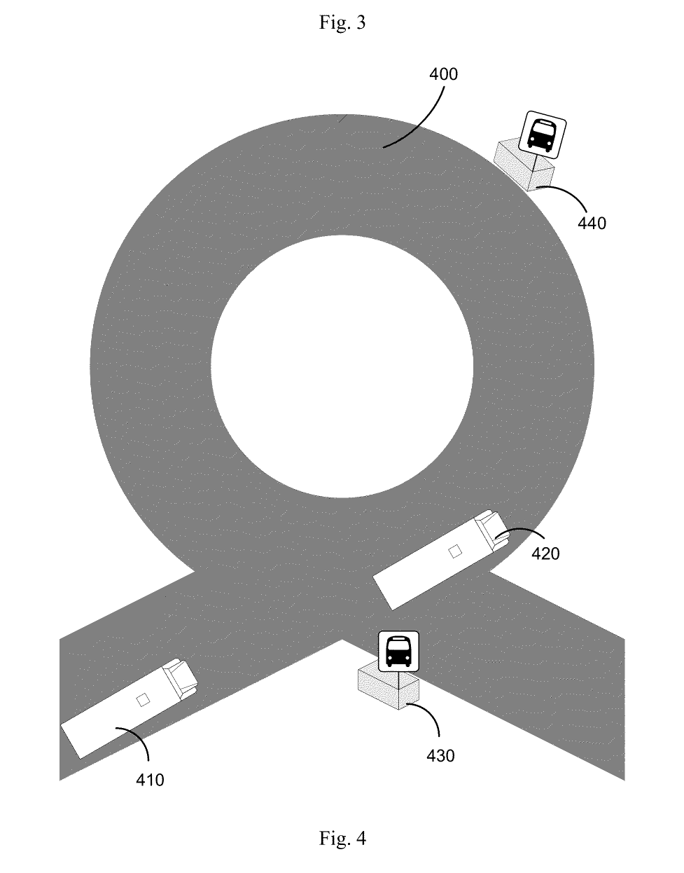

FIG. 4 is a schematic top view diagram depicting another road lane for describing the use of a system for accurately timing the stations, according to an embodiment of the invention. In this embodiment both buses 410 and 420 are traveling in the same lane, following the same public transportation route, and are designated to stop at the bus stations 430 and 440. As depicted, the buses following the public transportation route are required to turn around in a traffic circle 400 and stop at bus station 440 before stopping at bus station 430. Although, technically, bus 410 is closer to the bus station 430 than to bus station 440, the system 300, as described in relations to FIG. 1, calculates that the next station is bus station 440 based on the route stored in the system 300. Thus the system 300 can distinguish which bus station precedes which bus station in this figure, as well as in more complex scenarios, such as in routes with many cycles.

The system 300 as described in relations to FIG. 1 may also be used for public transportation vehicles which travel near the same station twice en route but are intended to stop at the station only once. Since the station is linked with the stored route the station may be announced only in relation to the intended stop. Furthermore, the system may be used for accurately timing the correct stations en route while disregarding other stations which may be close by, such as, stations on the other side of the street or stations on parallel roads.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for timing the arrival of a public transportation vehicle to a station on a route comprising the steps of:
a. receiving at least one said route for said public transportation vehicle;
b. receiving the location of at least one said station on said route;
c. receiving at least one GPS reading, indicative of the location of said public transportation vehicle;
d. calculating the location of said public transportation vehicle in relations to said route;
e. calculating the distance of the route between said location of said public transportation vehicle to said station; and
f. calculating the time required for said public transportation vehicle to travel to said station based on at least said distance to said station.

2. A method according to claim 1, where the GPS readings are used for calculating the direction of the vehicle.

3. A method according to claim 1, where the GPS readings are used for calculating the velocity of the vehicle.

4. A method according to claim 1, where the GPS readings are processed using information from the speedometer or the odometer of the vehicle to determine the location of the vehicle.

5. A method according to claim 1, where the GPS readings are also used to ascertain that the vehicle is traveling en route.

6. A method according to claim 1, where the calculating of the location of said public transportation vehicle in relations to said route comprises the steps of:
a. determining the direction of the vehicle using the GPS readings;
b. identifying the first route edge;
c. calculating the distance from the current location of said vehicle to said identified route edge;
d. searching the routes database for other route edges following said identified edge in said route whose direction is within the preset tolerance angle from said vehicle direction;
e. finding the edge with the minimum distance from current location among said found route edges; and
f. determining that the location of the vehicle in relation to said route is the location on the said edge whose distance to said vehicle is minimal.

7. A method according to claim 6, where the found route edge with the minimum distance to the vehicle location is used as the first route edge.

8. A method according to claim 6, where it is determined that the vehicle has strayed from the route if no route edges are found whose direction is within the preset tolerance angle of the direction of the vehicle.

9. A method according to claim 6, where it is determined that the vehicle has strayed from the route if no edges are found whose distance from the current location of said vehicle is within the preset distance tolerance.

10. A method according to claim 1, where the found time for the public transportation vehicle to travel to the station is used for announcing the arrival to the station.

11. A method according to claim 6, where it is determined that the vehicle is traveling en route if an edge is found whose direction is within the preset angle tolerance of the direction of the vehicle, and its distance from the current vehicle location is within the preset distance tolerance.
